(19) United States
(12) Patent Application Publication
(10) Pub. No.: US 2022/0198723 A1
(43) Pub. Date: Jun. 23, 2022

(54) IMAGE ENHANCEMENT METHOD AND IMAGE ENHANCEMENT APPARATUS

(71) Applicant: MEDIATEK INC., Hsin-Chu (TW)

(72) Inventors: Yu-Ju Lin, Hsinchu City (TW); Pin-Chung Lin, Hsinchu City (TW); Hung-Chih Ko, Hsinchu City (TW); Chia-Hui Kuo, Hsinchu City (TW); Shao-Yang Wang, Hsinchu City (TW); Keh-Tsong Li, Hsinchu City (TW); Ying-Jui Chen, Hsinchu City (TW); Chi-Cheng Ju, Hsinchu City (TW)

(73) Assignee: MEDIATEK INC., Hsin-Chu (TW)

(21) Appl. No.: 17/553,704

(22) Filed: Dec. 16, 2021

Related U.S. Application Data
(60) Provisional application No. 63/126,582, filed on Dec. 17, 2020.

(51) Int. Cl. G06T 11/00; G06T 7/13; G06V 10/74; G06T 7/30; G06T 5/00; G06V 10/75

(52) U.S. Cl. CPC G06T 11/001; G06T 7/13; G06V 10/761; G06T 2207/20221; G06T 5/002; G06V 10/752; G06T 7/30

(57) ABSTRACT

An image enhancement method applied to an image enhancement apparatus and includes acquiring a first edge feature from a first spectral image and a second edge feature from a second spectral image, analyzing similarity between the first edge feature and the second edge feature to align the first spectral image with the second spectral image, acquiring at least one first detail feature from the first spectral image and at least one second detail feature from the second spectral image, comparing the first edge feature and the second edge feature to generate a first weight and a second weight, and fusing the first detail feature weighted by the first weight with the second detail feature weighted by the second weight to generate a fused image. The first spectral image and the second spectral image are captured at the same point of time.

### CROSS REFERENCE TO RELATED APPLICATIONS

This application claims the benefit of U.S. provisional application No. 63/126,582 (which was filed on 2020, Dec. 17). The entire contents of the related application are incorporated herein by reference.

### BACKGROUND

A surveillance camera can be installed at the street corner, the highway or in front of the house to capture the surveillance image. The surveillance camera actuates a visible spectral receiver to capture the visible surveillance image in response to the luminous environment, and further actuates an invisible spectral receiver to capture the invisible surveillance image in response to the dark environment. The invisible surveillance image may be greenish or other colors and does not look like the vision image with various color and correct luminance. Therefore, design of a surveillance camera capable of providing images with an accurate shape and the correct color and luminance of a target object is an important issue in the image processing industry.

### SUMMARY

The present invention provides an image enhancement method and a related image enhancement apparatus of acquiring a clear image in a low light condition for solving above drawbacks.

According to the claimed invention, an image enhancement method includes acquiring a first edge feature from a first spectral image and a second edge feature from a second spectral image, analyzing similarity between the first edge feature and the second edge feature to align the first spectral image with the second spectral image, acquiring at least one first detail feature from the first spectral image and at least one second detail feature from the second spectral image, comparing the first edge feature and the second edge feature to generate a first weight and a second weight, and fusing the first detail feature weighted by the first weight with the second detail feature weighted by the second weight to generate a fused image. The first spectral image and the second spectral image are captured at the same point of time.

According to the claimed invention, a step of acquiring the first edge feature from the first spectral image includes extracting at least one gradient value of adjacent pixels of the first spectral image in a gradient domain to set as the first edge feature.

According to the claimed invention, a step of acquiring the first edge feature from the first spectral image includes extracting two gradient values of the adjacent pixels in different directions to define an angle of the first edge feature.

According to the claimed invention, the image enhancement method further includes analyzing the first edge feature and the second edge feature via an edge-based block matching algorithm to compute the similarity, such that a matching result is generated.

According to the claimed invention, the image enhancement method further includes searching a plurality of predefined directions for edge similarity via the edge-based block matching algorithm to find out a matching point of the first edge feature and the second edge feature for acquiring the similarity.

According to the claimed invention, the image enhancement method further includes refining the matching result via an occlusion handling algorithm and a consistency check algorithm.

According to the claimed invention, the image enhancement method further includes utilizing a bilateral solver like algorithm to interpolate a sparse disparity map of a matching result to a dense disparity map if the matching result of the first edge feature and the second edge feature is sparse, and warping the first spectral image in a pixel shifting manner according to the interpolated disparity map to align with the second spectral image.

According to the claimed invention, the image enhancement method further includes marking a pixel or a region within the first spectral image and/or the second spectral image for edge mismatching via an edge characteristic notation.

According to the claimed invention, the image enhancement method further includes assigning the first weight and the second weight respectively based on the first edge feature matching with the second edge feature in accordance with the edge characteristic notation.

According to the claimed invention, the first spectral image is an invisible spectral image, the second spectral image is a visible spectral image, and the weighting value of the first weight is greater than the weighting value of the second weight.

According to the claimed invention, both the first spectral image and the second spectral image comprise a plurality of layers in accordance with a specific attribute, more than one first detail features and second detail features are acquired from the first spectral image and the second spectral image respectively, and the specific attribute is frequency distribution or resolution of the first spectral image.

According to the claimed invention, the image enhancement method further includes shrinking the second spectral image, and applying an edge preserve smoothing algorithm to the shrunk second spectral image.

According to the claimed invention, the image enhancement method further includes setting a confidence map, transforming the second spectral image via the confidence map to acquire a sparse color image, and colorizing the fused image with the sparse color image to generate a natural visual color image.

According to the claimed invention, sparse color information of the sparse color image is filled into a corresponding region of the fused image, and propagated to an adjacent region around the corresponding region to generate the natural visual color image.

According to the claimed invention, an image enhancement apparatus includes a first image receiver, a second image receiver and an operation processor. The first image receiver is adapted to receive a first spectral image. The second image receiver is adapted to receive a second spectral image, and the first spectral image and the second spectral image are captured at the same point of time. The operation processor is electrically connected to the first image receiver and the second image receiver. The operation processor is adapted to acquiring a first edge feature from the first spectral image and a second edge feature from the second spectral image, analyze similarity between the first edge feature and the second edge feature to align the first spectral image with the second spectral image, acquire at least one first detail feature from the first spectral image and at least one second detail feature from the second spectral image, compare the first edge feature and the second edge feature to generate a first weight and a second weight, and fuse the first detail feature weighted by the first weight with the second detail feature weighted by the second weight to generate a fused image.

The image enhancement apparatus can utilize two image receivers to respectively derive the first spectral image and the second spectral image; intensity of the first spectral image and the second spectral image are not actually related due to the invisible spectrum and the visible spectrum. The different spectral images can respectively record different image colors or different edges; for example, in the low light condition, the first spectral image (the invisible spectral image) has the rich details in the edge feature, and the second spectral image (the visible spectral image) has less edge details and hardly reliable color information. The edge feature in the first spectral image can be recorded and color information in the first spectral image can be ignored; the edge feature in the second spectral image can be ignored and the correct color information in the second spectral image can be recorded. The first weight of the first edge feature may be increased and greater than the second weight of the second edge feature for keeping the richest edge details in the spectral images. Thus, the edge based local alignment with the specific angle weight and the specific angle notation can strengthen correctness of the matching result to get preferred edge judgment for fusion. The visible spectral image may have noise in the low light condition, so that the visible spectral image can be shrunk, such as bilinear or bi-cubic interpolation, to reduce the noise and reserve the reliable edge feature, and be used to fill into the fused image for colorizing and generating the natural visual color image with enriched image details, improved visual identification and strengthened recognition accuracy.

Besides, the image enhancement apparatus may be implemented by an active light source or without the active light source. The image enhancement method may be implemented by hardware or software, or implemented on the mobile device or the surveillance camera or the night vision device or other camera gadgets in near real-time or real-time, or implemented on the cloud server by transferring relevant data via internet. The image enhancement apparatus can be installed at the street corner, the highway or in front of the house, and the image quality of the image enhancement apparatus can be enhanced by the image enhancement method of the present invention and not be interfered with fog or extremely dark environment for making the target object clear.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an image enhancement apparatus according to an embodiment of the present invention.

FIG. 2 is a flow chart of an image enhancement method according to the embodiment of the present invention.

FIG. 3 is a flow char of the edge based local alignment according to the embodiment of the present invention.

FIG. 4 is a flow chart of fusing the first spectral image and the second spectral image according to the embodiment of the present invention.

FIG. 5 is a flow chart of color recovery according to the embodiment of the present invention.

### DETAILED DESCRIPTION

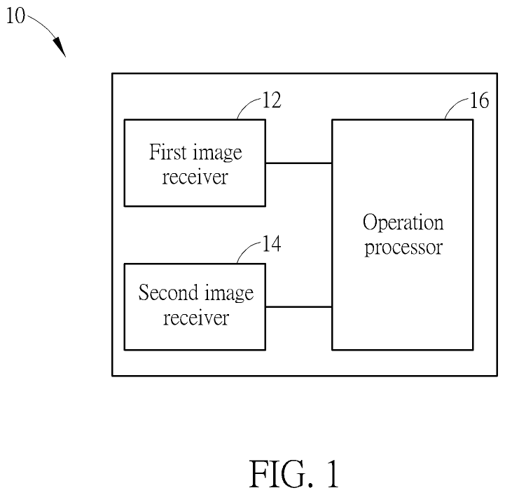

Please refer to FIG. 1. FIG. 1 is a functional block diagram of an image enhancement apparatus 10 according to an embodiment of the present invention. The image enhancement apparatus 10 can be used for object tracking, feature recognition and feature interpretation, and be widely used on home safety, traffic accident tracking and plate recognition. The image enhancement apparatus 10 can be preferably worked in a normal light condition; when the environment turns darker, the image enhancement apparatus 10 can gather images captured by specific spectral light to make a target object be seen in a low light condition.

For example, the vision image captured by visible light may have clear color but a blurred edge of the target object, and the image captured by invisible light, such as a near infrared image or a thermal image, may have an accurate edge of the target object but no color and no correct luminance. Therefore, the image enhancement apparatus 10 can acquire two or more spectral images and then fuse strength and information of multi-spectral images to make the target object clear and distinct, so that an appearance of the target object in the fused image can be looked like human vision even the image enhancement apparatus 10 is worked in an extremely dark environment.

The image enhancement apparatus 10 can include a first image receiver 12, a second image receiver 14 and an operation processor 16. The first image receiver 12 can receive at least one first spectral image captured by the first image sensor, or can directly capture the at least one first spectral image. The second image receiver 14 can receive at least one second spectral image captured by the second image sensor, or can directly capture the at least one second spectral image. The first image sensor and the second image sensor are not shown in FIG. 1. The first spectral image and the second spectral image can be captured at the same point of time, and respectively can be an invisible spectral image and a visible spectral image.

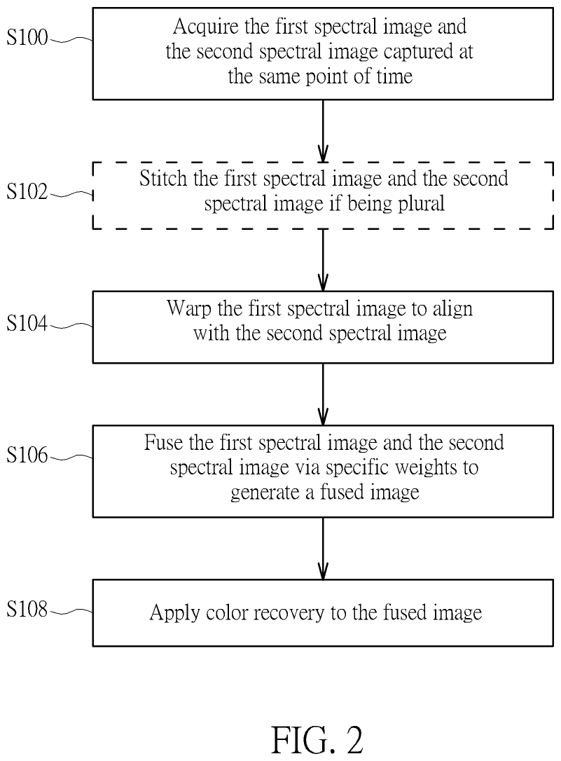

Please refer to FIG. 2. FIG. 2 is a flow chart of an image enhancement method according to the embodiment of the present invention. The image enhancement method illustrated in FIG. 2 can be applied for the operation processor 16 of the image enhancement apparatus 10 shown in FIG. 1. First, step S100 can be executed to acquire at least one first spectral image and at least one second spectral image. If numbers of the first spectral image and the second spectral image are plural and a plurality of first spectral images and a plurality of second spectral images respectively correspond to different parts of a surveillance region of the image enhancement apparatus 10, step S102 can be optionally executed to stitch the plurality of first spectral images for forming a first panoramic image and further stitch the plurality of second spectral images for forming a second panoramic image. For example, the plurality of first spectral images may include two or more than two near infrared images, and the plurality of second spectral images may include two or more than two color images. The near infrared images and the color images can be stitched for steps of edge based local alignment, image fusion, and color recovery, which are respectively illustrated in the following description.

The first spectral image and the second spectral image are captured at different angles of vision, so that step S104 can execute the edge based local alignment to warp the first spectral image for aligning with the second spectral image. The first spectral image is the invisible spectral image that has richest details and the accurate edge of the target object, and the second spectral image is the visible spectral image that has little details and the accurate edge of the target object, so that step S106 can adjust a weight of the first spectral image and then further adjust a weight of the second spectral image in accordance with weight adjustment of the first spectral image to fuse the first spectral image and the second spectral image for generating a fused image. Final, step S108 can be executed to use color extraction algorithm to retrieve correct color information of the fused image via any applicable colorization method.

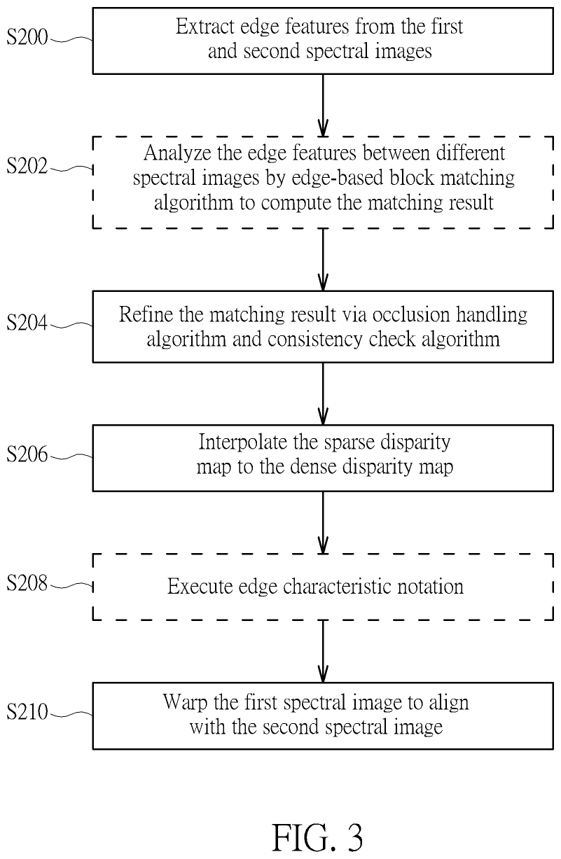

Please refer to FIG. 3. FIG. 3 is a flow chart of the edge based local alignment in step S104 according to the embodiment of the present invention. First, step S200 can be executed to acquire at least one first edge feature from the first spectral image (or the first panoramic image) and at least one second edge feature from the second spectral image (or the second panoramic image). In an example of the image enhancement method, the first edge feature can be calculated from gradient value of neighboring pixels and the larger gradient value can be defined as an edge. In the present invention, the edge method for acquiring the first edge feature and the second edge feature can utilize a Sobel filter or other common used edge extraction methods to extract the gradient values of adjacent pixels; the Sobel filter can be used to compute a gradient map for the first spectral image and the second spectral image, and one or some of the gradient values in the gradient map that exceed a predefined threshold can be defined as the first or second edge feature via its gradient magnitude. The related edge method that is used in the present invention can be a combination of edge collection (such as being acquired by the Sobel filter) and calculating gradient along the horizontal and vertical directions for defining a precisely angle (such as being acquired by trigonometric functions). Therefore, edge correctness can be enhanced by referencing the edge angle similarity.

Then, step S202 can be executed to analyze the angle and strength of the first edge feature and the second edge feature via an edge-based block matching algorithm for computing similarity between the first edge feature and the second edge feature, such that a matching result is generated. The spectral images may be marked by several windows, and the edge-based block matching algorithm can be implemented based on a sum of absolute difference of specific parameters of pixels within the given window. The matching result of each pixel between the spectral images can be computed in accordance with the similarity of gradient magnitude and orientation. Thus, the edge-based block matching algorithm can search a plurality of predefined directions for edge similarity to find out a matching point of the first edge feature and the second edge feature, so as to acquire the similarity; for example, the present invention can search a left side and a right side for the edge similarity between the first spectral image and the second spectral image to find the best matching point. Moreover, a semi-global matching algorithm may be optionally used to optimize the matching result, which depends on the design demand, and a detailed description is omitted herein for simplicity.

If the edge feature in at least one of the first spectral image and the second spectral image is dense, the similarity can be preferably acquired in step S202; if the edge feature in at least one of the first spectral image and the second spectral image is sparse, some areas in the foresaid spectral image that have sparse edge feature can be calibrated by surrounding areas in the foresaid spectral image or related areas in another spectral image that have sufficient or dense edge feature, and therefore step S204 can be optionally executed to refine the matching result via an occlusion handling algorithm and a consistency check algorithm. The occlusion handling algorithm can prune out the similarity at occluded location of the first spectral image and the second spectral image, and the consistency check algorithm can examine consistency of the similarity between the left side and the right side of the spectral images; application of the occlusion handling algorithm and the consistency check algorithm depends on a design demand, and a detailed description is omitted herein for simplicity.

Then, steps S206, S208 and S210 can be executed to utilize a bilateral solver like algorithm to interpolate a sparse disparity map of the matching result of the first edge feature and the second edge feature to a dense disparity map if the matching result is sparse, and marking a pixel or a region within at least one of the first spectral image and the second spectral image for edge mismatching via an edge characteristic notation, and warp the first spectral image in a pixel shifting manner according to the interpolated disparity map to align with the second spectral image. Thus, one of the first spectral image and the second spectral image can be warped by the pixel shifting manner to align with another spectral image.

The edge characteristic notation may be optionally applied for marking the pixel or the region that the first spectral image has the edge feature but the second spectral image has no edge feature, or both the first spectral image and the second spectral image have no edge feature detected. The edge based local alignment can compare the first edge feature with the second edge feature, to generate and assign a first weight and a second weight based on the first edge feature matching with the second edge feature in accordance with the edge characteristic notation. The first weight may be greater than the second weight because the first edge feature of the first spectral image is distinct or clear and the second edge feature of the second spectral image is unobvious or blurred. The first weight may be smaller than the second weight when the first edge feature of the first spectral image is unobvious or blurred and the second edge feature of the second spectral image is distinct or clear. The first spectral image has the large first weight (greater than the second weight of the second spectral image) for maintaining the rich details.

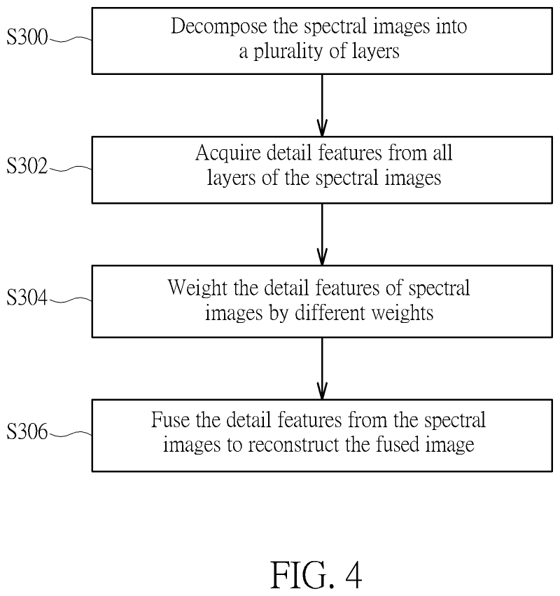

Please refer to FIG. 4. FIG. 4 is a flow chart of fusing the first spectral image and the second spectral image in step S106 according to the embodiment of the present invention. First, step S300 can be executed to decompose the first spectral image and the second spectral image into a plurality of layers in accordance with a specific attribute. The specific attribute may be frequency distribution or resolution of the first spectral image and the second spectral image, which depends on the design demand. A multilayer method used in step S300 may be, but not limited to, a bilateral filter, a weighted median filter, a guided filter, or any similar filter. Then, step S302 can be executed to acquire one or more first detail features, from coarse to fine, from all layers of the first spectral image and further acquire one or more second detail features, from coarse to fine, from all layers of the second spectral image.

All layers of the first spectral image and the second spectral image can have respective weights in accordance with the edge characteristic notation, so that step S304 can be executed to weight the first detail features of the first spectral image by the first weight and further to weight the second detail features of the second spectral image by the second weight. The first weight is greater than the second weight because the first edge feature has clear edge, so that the image enhancement method can refer to matching correctness of the first edge feature and the second edge feature for avoiding evidently false matching and instead provide a less distinct appearance. In some embodiments, the information about the matching correctness of the first edge feature and the second edge can be obtained from the results generated by step 208. Then, step S306 can be executed to fuse the weighted first detail features with the weighted second detail features for reconstructing a fused image with a preferred detail and preferred contrast fusion result.

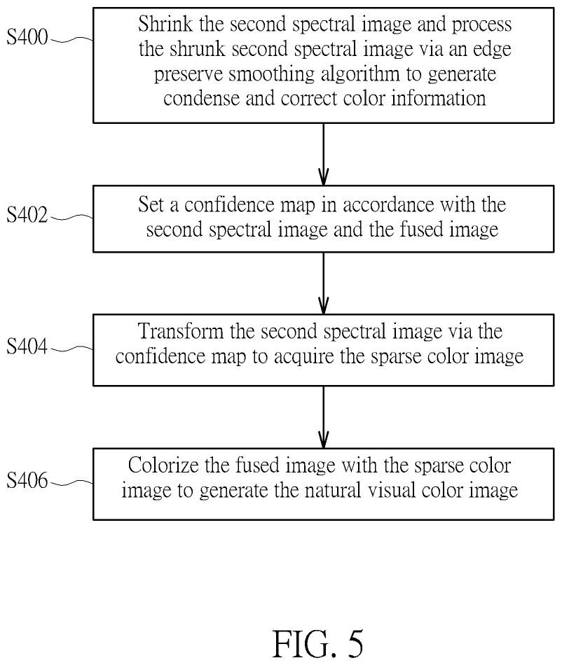

Please refer to FIG. 5. FIG. 5 is a flow chart of color recovery in step S108 according to the embodiment of the present invention. First, with barely reliable color information in the low light condition, step S400 can be optionally executed to shrink the second spectral image and process the shrunk second spectral image via an edge preserve smoothing algorithm to generate condense and correct color information. The edge preserve smoothing algorithm may be used to smooth a small gradient value and retain a large gradient value of the evident edge feature in the second spectral image, for eliminating noise and preserving obvious edges to provide more accurate edge estimation. The edge preserve smoothing algorithm can be, but not limited to, L0 smoothing or L1 smoothing, or a gradient domain guided filter, which depends on the design demand.

Then, step S402 can be executed to set a confidence map in accordance with the second spectral image and the fused image. Each area of the second spectral image with condense and correct color information can have a confidence value as an accurate reference in a position and the target object between the second spectral image and the fused image to form the confidence map. The confidence value may be computed by the edge feature, a shape of the target object, or other characteristics in the spectral image. In some embodiments, the edge feature, a shape of the target object, or other characteristics in the spectral image can be obtained from the results generated by step 208.

As the confidence map is set, steps S404 and S406 can be executed to transform the second spectral image via the confidence map to acquire a sparse color image, and to colorize the fused image with the sparse color image to generate a natural visual color image. In step S406, sparse color information of the sparse color image can be filled into a corresponding region of the fused image, and further propagated to adjacent regions around the corresponding region via related colorization methods, such as geodesics based colorization, optimization based colorization or a guided filter, for generating the natural visual color image. The natural visual color image is a low light color image that possesses the clear edge feature of the first spectral image and the correct color information of the second spectral image.

In conclusion, the image enhancement apparatus can utilize two image receivers to respectively derive the first spectral image and the second spectral image; intensity of the first spectral image and the second spectral image are not actually related due to the invisible spectrum and the visible spectrum. The different spectral images can respectively record different image colors or different edges; for example, in the low light condition, the first spectral image (the invisible spectral image) has the rich details in the edge feature, and the second spectral image (the visible spectral image) has less edge details and hardly reliable color information. The edge feature in the first spectral image can be recorded and color information in the first spectral image can be ignored; the edge feature in the second spectral image can be ignored and the correct color information in the second spectral image can be recorded. The first weight of the first edge feature may be increased and greater than the second weight of the second edge feature for keeping the richest edge details in the spectral images. Thus, the edge based local alignment with the specific angle weight and the specific angle notation can strengthen correctness of the matching result to get preferred edge judgment for fusion. The visible spectral image may have noise in the low light condition, so that the visible spectral image can be shrunk, such as bilinear or bi-cubic interpolation, to reduce the noise and reserve the reliable edge feature, and be used to fill into the fused image for colorizing and generating the natural visual color image with enriched image details, improved visual identification and strengthened recognition accuracy.

It should be mentioned that the image enhancement apparatus may be implemented by an active light source or without the active light source. The image enhancement method may be implemented by hardware or software, or implemented on the mobile device, the surveillance camera or the night vision device or other camera gadgets in near real-time or real-time, or implemented on the cloud server by transferring relevant data via internet. Comparing to the prior art, the image enhancement apparatus can be installed at the street corner, the highway or in front of the house, and the image quality of the image enhancement apparatus can be enhanced by the image enhancement method of the present invention and not be interfered with fog or extremely dark environment for making the target object clear.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image enhancement method, comprising:
acquiring a first edge feature from a first spectral image and a second edge feature from a second spectral image, wherein the first spectral image and the second spectral image are captured at the same point of time;
analyzing similarity between the first edge feature and the second edge feature to align the first spectral image with the second spectral image;
acquiring at least one first detail feature from the first spectral image and at least one second detail feature from the second spectral image;
comparing the first edge feature and the second edge feature to generate a first weight and a second weight; and
fusing the first detail feature weighted by the first weight with the second detail feature weighted by the second weight to generate a fused image.

2. The image enhancement method of claim 1, wherein acquiring the first edge feature from the first spectral image comprises:
extracting at least one gradient value of adjacent pixels of the first spectral image in a gradient domain to set as the first edge feature.

3. The image enhancement method of claim 2, wherein acquiring the first edge feature from the first spectral image comprises:
extracting two gradient values of the adjacent pixels in different directions to define an angle of the first edge feature.

4. The image enhancement method of claim 1, further comprising:
analyzing the first edge feature and the second edge feature via an edge-based block matching algorithm to compute the similarity, such that a matching result is generated.

5. The image enhancement method of claim 4, further comprising:
searching a plurality of predefined directions for edge similarity via the edge-based block matching algorithm to find out a matching point of the first edge feature and the second edge feature for acquiring the similarity.

6. The image enhancement method of claim 4, further comprising:
refining the matching result via an occlusion handling algorithm and a consistency check algorithm.

7. The image enhancement method of claim 1, further comprising:
utilizing a bilateral solver like algorithm to interpolate a sparse disparity map of a matching result to a dense disparity map if the matching result of the first edge feature and the second edge feature is sparse; and
warping the first spectral image in a pixel shifting manner according to the interpolated disparity map to align with the second spectral image.

8. The image enhancement method of claim 1, further comprising:
marking a pixel or a region within the first spectral image and/or the second spectral image for edge mismatching via an edge characteristic notation.

9. The image enhancement method of claim 8, further comprising:
assigning the first weight and the second weight respectively based on the first edge feature matching with the second edge feature in accordance with the edge characteristic notation.

10. The image enhancement method of claim 1, wherein the first spectral image is an invisible spectral image, the second spectral image is a visible spectral image, and the first weight is greater than the second weight.

11. The image enhancement method of claim 1, wherein both the first spectral image and the second spectral image comprise a plurality of layers in accordance with a specific attribute, more than one first detail features and second detail features are acquired from the first spectral image and the second spectral image respectively, and the specific attribute is frequency distribution or resolution of the first spectral image and the second spectral image.

12. The image enhancement method of claim 1, further comprising:
shrinking the second spectral image; and
applying an edge preserve smoothing algorithm to the shrunk second spectral image.

13. The image enhancement method of claim 1, further comprising:
setting a confidence map;
transforming the second spectral image via the confidence map to acquire a sparse color image; and
colorizing the fused image with the sparse color image to generate a natural visual color image.

14. The image enhancement method of claim 13, wherein sparse color information of the sparse color image is filled into a corresponding region of the fused image, and propagated to an adjacent region around the corresponding region to generate the natural visual color image.

15. An image enhancement apparatus, comprising:
a first image receiver adapted to receive a first spectral image;
a second image receiver adapted to receive a second spectral image, wherein the first spectral image and the second spectral image are captured at the same point of time; and
an operation processor electrically connected to the first image receiver and the second image receiver, the operation processor being adapted to acquiring a first edge feature from the first spectral image and a second edge feature from the second spectral image, analyze similarity between the first edge feature and the second edge feature to align the first spectral image with the second spectral image, acquire at least one first detail feature from the first spectral image and at least one second detail feature from the second spectral image, compare the first edge feature and the second edge feature to generate a first weight and a second weight, and fuse the first detail feature weighted by the first weight with the second detail feature weighted by the second weight to generate a fused image.

16. The image enhancement apparatus of claim 15, wherein the operation processor is further adapted to extract at least one gradient value of adjacent pixels of the first spectral image in a gradient domain to set as the first edge feature.

17. The image enhancement apparatus of claim 16, wherein the operation processor is further adapted to extract two gradient values of the adjacent pixels in different directions to define an angle of the first edge feature.

18. The image enhancement apparatus of claim 15, wherein the operation processor is further adapted to analyze the first edge feature and the second edge feature via an edge-based block matching algorithm to compute the similarity, such that a matching result is generated.

19. The image enhancement apparatus of claim 18, wherein the operation processor is further adapted to search a plurality of predefined directions for edge similarity via the edge-based block matching algorithm to find out a matching point of the first edge feature and the second edge feature for acquiring the similarity.

20. The image enhancement apparatus of claim 18, wherein the operation processor is further adapted to refine the matching result via an occlusion handling algorithm and a consistency check algorithm.

21. The image enhancement apparatus of claim 15, wherein the operation processor is further adapted to utilize a bilateral solver like algorithm to interpolate a sparse disparity map of a matching result to a dense disparity map if the matching result of the first edge feature and the second edge feature is sparse, and the first spectral image in a pixel shifting manner according to the interpolated disparity map to align with the second spectral image.

22. The image enhancement apparatus of claim 15, wherein the operation processor is further adapted to mark a pixel or a region within the first spectral image and/or the second spectral image for edge mismatching via an edge characteristic notation.

23. The image enhancement apparatus of claim 22, wherein the operation processor is further adapted to assign the first weight and the second weight respectively based on the first edge feature matching with the second edge feature in accordance with the edge characteristic notation.

24. The image enhancement apparatus of claim 15, wherein the first spectral image is an invisible spectral image, the second spectral image is a visible spectral image, and the weighting value of the first weight is greater than the weighting value of the second weight.

25. The image enhancement apparatus of claim 15, wherein both the first spectral image and the second spectral image comprise a plurality of layers in accordance with a specific attribute, more than one first detail features and second detail features are acquired from the first spectral image and the second spectral image respectively, and the specific attribute is frequency distribution or resolution of the first spectral image and the second spectral image.

26. The image enhancement apparatus of claim 15, wherein the operation processor is further adapted to shrink the second spectral image, and apply an edge preserve smoothing algorithm to the shrunk second spectral image.

27. The image enhancement apparatus of claim 15, wherein the operation processor is further adapted to set a confidence map, transform the second spectral image via the confidence map to acquire a sparse color image, and colorize the fused image with the sparse color image to generate a natural visual color image.

28. The image enhancement apparatus of claim 27, wherein sparse color information of the sparse color image is filled into a corresponding region of the fused image, and propagated to an adjacent region around the corresponding region to generate the natural visual color image.
